(19) United States
(12) Patent Application Publication
(10) Pub. No.: US 2006/0266510 A1
(43) Pub. Date: Nov. 30, 2006

(54) Information processing apparatus and a method of controlling the same

(75) Inventor: Kumiko Nobashi, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/438,339

(22) Filed: May 23, 2006

(30) Foreign Application Priority Data
May 24, 2005 (JP) 2005-151038

(51) Int. Cl. G05D 23/00

(52) U.S. Cl. 165/287; 165/299

(57) ABSTRACT

There is provided an information processing apparatus including temperature sensors associated with a CPU, a graphic controller, and a RAM, which are objects to be cooled, a first fan and a second fan, and control tables which correspond to the respective temperature sensors and set a plurality of predetermined temperature ranges as control levels and each of which stores rotation numbers of the respective cooling fans corresponding to the control levels. A maximum value for each cooling fan is determined from the rotation numbers of the cooling fan corresponding to the control levels corresponding to temperature information from the temperature sensors, and each cooling fan is controlled based on the maximum value.

### CROSS-REFERENCE TO RELATED APPLICATIONS

This application is based upon and claims the benefit of priority from Japanese Patent Application No. 2005-151038, filed May 24, 2005, the entire contents of which are incorporated herein by reference.

### BACKGROUND

1. Field

The present invention relates to control of a cooling fan for a personal computer, in particular, relates to an information processing apparatus and a controlling method of the same, which efficiently control cooling fans of a number smaller than that of temperature sensors, on the basis of information from the temperature sensors.

2. Description of the Related Art

In recent laptop computers and notebook personal computers, it is required to sufficiently lower the surface temperature of a housing, as well as the temperature of a CPU. In particular, it is necessary to suppress increase in temperature due to heat generated by a memory and a graphic board, etc. Further, since rotating a fan for cooling involves reduction in the battery drivable time and generation of noises, it is required to prevent the fan from rotating as much as possible, and prevent increase in rotation number (per unit time) of the fan as much as possible. Therefore, it is desired to efficiently cool the CPU and the like by the cooling fan.

In prior art, a plurality of cooling fans are provided for a plurality of objects to be cooled, such as a CPU, a memory, and a graphic board, etc., in a one-to-one relationship, and are controlled on the basis of information from temperature sensors (for example, refer to Jpn. Pat. Appln. KOKAI Pub. No. 11-259001).

In the meantime, laptop computers and notebook personal computers have been downsized, and there are cases where providing cooling fans for respective objects to be cooled in a one-to-one relationship is difficult in terms of space. In such a case, since cooling fans are not provided in a one-to-one relationship with a plurality of objects to be cooled, it is difficult to appropriately control the cooling fans.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram illustrating a structure of a notebook personal computer being an information processing apparatus according to an embodiment of the present invention.

FIG. 2 is a block diagram illustrating a system configuration of the computer.

FIG. 3 is a block diagram illustrating an EC/KBC, and a first temperature sensor, a second temperature sensor, a third temperature sensor, a first fan and a second fan, which are connected to the EC/KBC.

FIG. 4 is a schematic diagram illustrating placement of the fans, heat-generating members, and the temperature sensors.

FIG. 5 is a block diagram illustrating a method of controlling the cooling fans, to which the information processing apparatus according to the embodiment of the present invention is applied.

FIG. 6 is a flowchart illustrating changing a control level by the EC/KBC.

FIG. 7 is a flowchart illustrating controlling the cooling fans by the EC/KBC.

FIG. 8 is a schematic diagram of a control table corresponding to the first temperature sensor, stored in a table information storage area of the EC/KBC.

FIG. 9 is a schematic diagram of a control table corresponding to the second temperature sensor, stored in the table information storage area of the EC/KBC.

FIG. 10 is a schematic diagram of a control table corresponding to the third temperature sensor, stored inn the table information storage area of the EC/KBC.

FIG. 11 is a schematic diagram illustrating transition of a control level based on the control table for the first temperature sensor.

FIG. 12 is a schematic diagram of a register storing a current control value (threshold temperature).

FIG. 13 is a schematic diagram of the register storing a current control value (rotation number of the cooling fans).

FIG. 14 is a schematic diagram of the register storing an updated control value (threshold temperature).

FIG. 15 is a schematic diagram illustrating rotation numbers of the first fan requested by the respective temperature sensors, and a maximum value thereof.

FIG. 16 is a schematic diagram illustrating rotation numbers of the second fan requested by the respective temperature sensors, and a maximum value thereof.

FIG. 17 is a schematic diagram of a register storing an updated control value (rotation numbers of the cooling fans).

### DETAILED DESCRIPTION

Various embodiments according to the invention will be described hereinafter with reference to the accompanying drawings. In general, according to one embodiment of the invention, an information processing apparatus comprising: a first heat-generating member; a first temperature sensor which measures a temperature of the first heat-generating member; a second heat-generating member; a second temperature sensor which measures a temperature of the second heat-generating member; a third heat-generating member; a third temperature sensor which measures a temperature of the third heat-generating member; a first cooling fan and a second cooling fan which are set in predetermined positions; and a controller which includes control table information items corresponding to the respective temperature sensors, the control table information items setting a plurality of predetermined temperature ranges as control levels and providing rotation numbers of the respective cooling fans corresponding to the predetermined temperature ranges, the controller determining a maximum value of each cooling fan among the rotation numbers of the cooling fan corresponding to the control levels corresponding to temperature information from the temperature sensors, and controlling each cooling fan based on the maximum value.

An embodiment of the present invention is explained below, with reference to drawings.

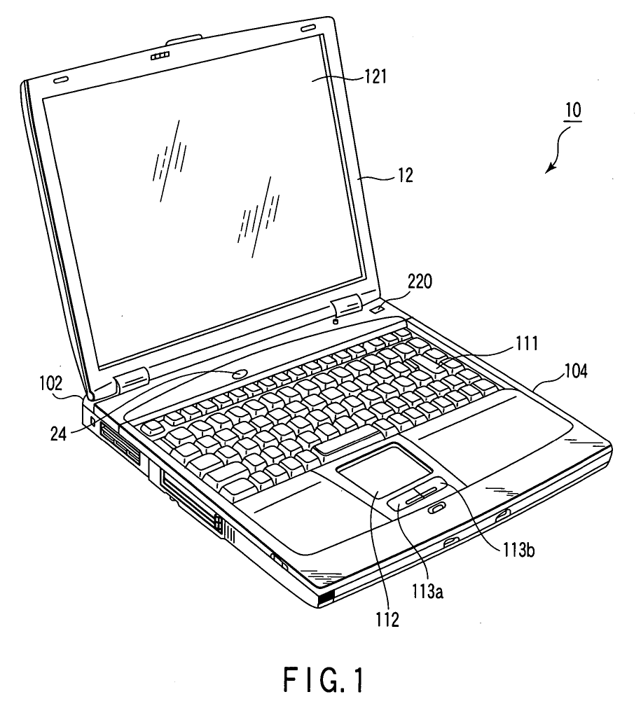

FIG. 1 is a diagram illustrating a structure of a notebook personal computer being an information processing apparatus according to an embodiment of the present invention.

As shown in FIG. 1, a computer 10 comprises a computer 10 (computer main body?) and a display unit 12. A display device formed of an LCD (Liquid Crystal Display) is incorporated into the display unit 12. A display screen 121 of the LCD is positioned in almost the center of the display unit 12.

The display unit 12 is attached to the computer 10 such that the display unit 12 is rotatable between an open position and a closed position. The main body of the computer 10 has a thin box-shaped housing. On a top surface of the housing, provided are a power button 114 and a keyboard 111. On a palm rest on the top surface of the housing, provided are a touch pad 112 and a left and a right buttons 113a and 113b, etc. Further, air outlets 102 and 100 for cooling fans are provided on a back surface and a left side surface of the housing, respectively, and an air inlet 104 serving as an air intake port is provided on a right side surface of the housing.

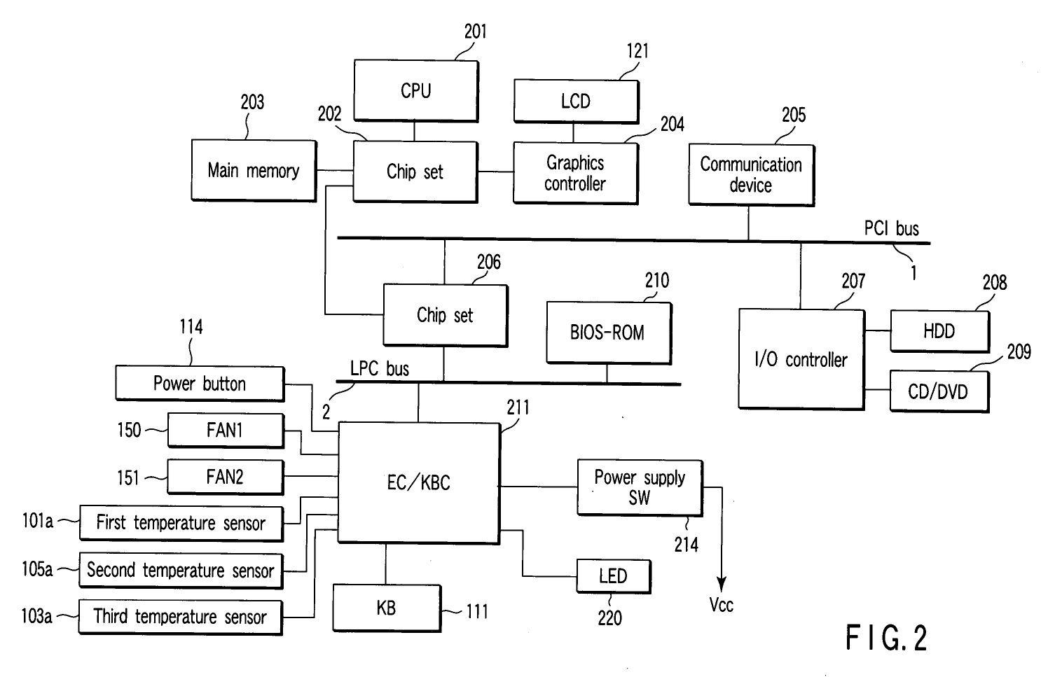

FIG. 2 is a block diagram illustrating a system configuration of the computer 10.

The computer 10 comprises a CPU 201, a chip set 202, a main memory (hereinafter referred to as “RAM”) 203, a graphics controller 204, a communication device 205, a chip set 206, an I/O controller 207, a hard disk drive (HDD) 208, a CD/DVD drive 209, a BIOS-ROM 210, an embedded controller/keyboard controller IC (hereinafter referred to as “EC/KBC”) 211, a first fan 150, a second fan 151, a first temperature sensor 101a, a second temperature sensor 105a, and a third temperature sensor 103a, etc. Although the temperature sensors are provided side by side in FIG. 2 for convenience sake, in the actual mounting, the first temperature sensor 101a is disposed in the vicinity of the CPU 201, the second temperature sensor 105a in the vicinity of the graphic board (graphics controller 204), and the third temperature sensor 103a in the vicinity of the RAM 203 (refer to FIG. 4).

The CPU 201 is a processor provided to control operation of the computer 10. The CPU 201 runs an operating system (operation system) and an application program/utility program loaded from the hard disk drive (HDD) 208 into the RAM 203. Further, the CPU 201 also executes a BIOS (Basic Input Output System) stored in the BIOS-ROM 210.

The chip set 202 is a bridge device which establishes a bi-directional connection between a local bus of the CPU 201 and an LPC bus 2. The graphics controller 204 controls the display screen 121 of the LCD used as a display monitor of the computer 10. The communication device 205 is a PCI device, and used for connection to computer networks such as the Internet. The I/O controller 207 is also a PCI device, and includes an IDE controller which controls the hard disk drive (HDD) 208 and the CD/DVD drive 209, and the like.

The chip set 206 is a bridge device which establishes a bi-directional connection between a PCI bus 1 and the LPC bus 2, and includes various system devices, such as a system timer, a DMA controller, and an interrupt controller.

The EC/KBC 211 is a one-chip microcomputer formed by integrating an embedded controller for electric power control and a keyboard controller which controls the keyboard 111. The EC/KBC 211 has a function of powering on and off the computer 10, in response to the operation of the power button 114. Further, the EC/KBC 211 controls the first fan 150 and the second fan 151 on the basis of information from the first temperature sensor 101a, the second temperature sensor 105a, and the third temperature sensor 103a.

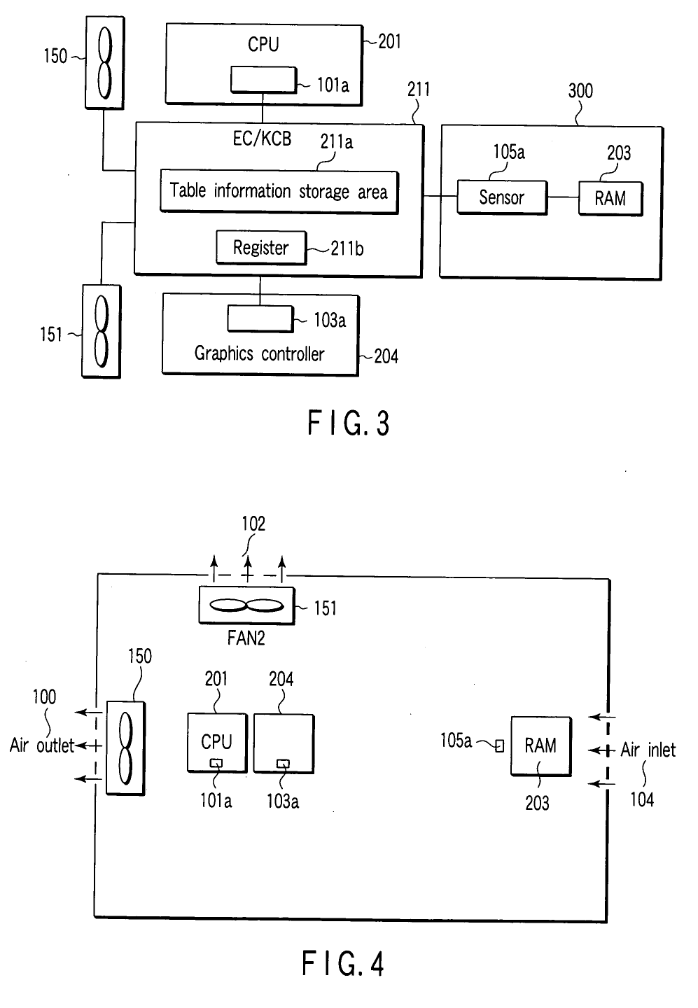

FIG. 3 is a block diagram illustrating the EC/KBC 211, and the first temperature sensor 101a, the second temperature sensor 105a, and the third temperature sensor 103a, the first fan 150 and the second fan 151, which are connected to the EC/KBC 211. Specifically, the temperature sensors 101a and 103a are thermistors included in the CPU 201 and the graphics controller 204, respectively. The second temperature sensor 105a is mounted together with and in the vicinity of the RAM 203 on a substrate 300.

The EC/KBC 211 has a table information storage area 211a which stores control tables for controlling the fans on the basis of the information from the temperature sensors, and a register 211b which temporarily stores various control values (such as rotation numbers of the fans, and threshold temperatures of the temperature sensors) used for controlling the fans.

FIG. 4 is a schematic diagram illustrating placement of the fans, heat-generating members, and the temperature sensors.

As described above, the first temperature sensor 101a is included in the CPU 201 as a thermistor, and the third temperature sensor 103a is included in the graphics controller 204 as a thermistor in the same manner. The second temperature sensor 105a is disposed in the vicinity of the RAM 203. Further, the air outlet 102 for the second fan 151 is provided in the back surface of the computer 10, and the air outlet 100 for the first fan 150 is provided in the left side surface of the computer 10. The air inlet 104 being an air intake port is provided in the right side surface of the computer 10.

The present invention is particularly effective for structures as described above, in which the total number (two) of the cooling fans (first fan 150 and second fan 151) is smaller than the total number (three) of the objects to be cooled (CPU 201, graphics controller 204, and RAM 203), that is, the cases where a plurality of cooling fans and a plurality of objects to be cooled do not have one-to-one correspondences.

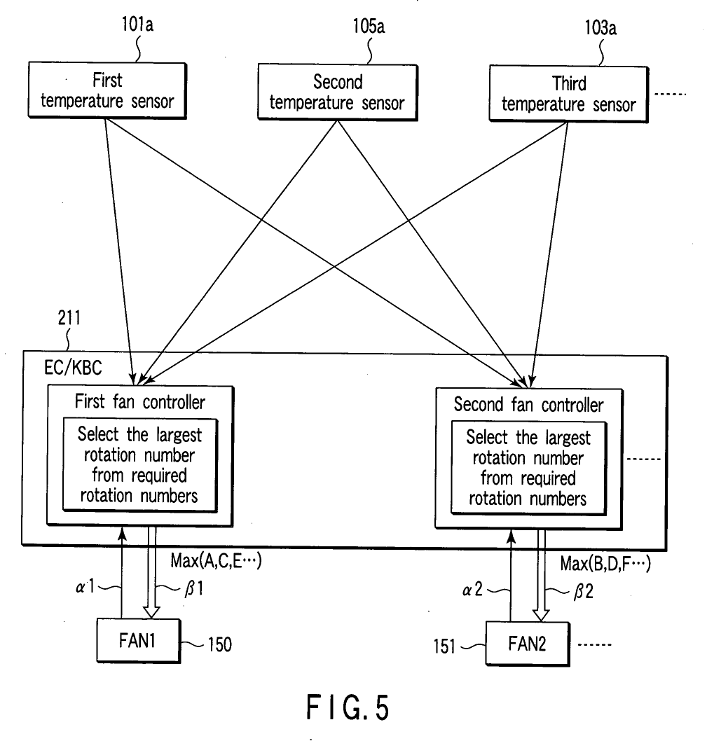

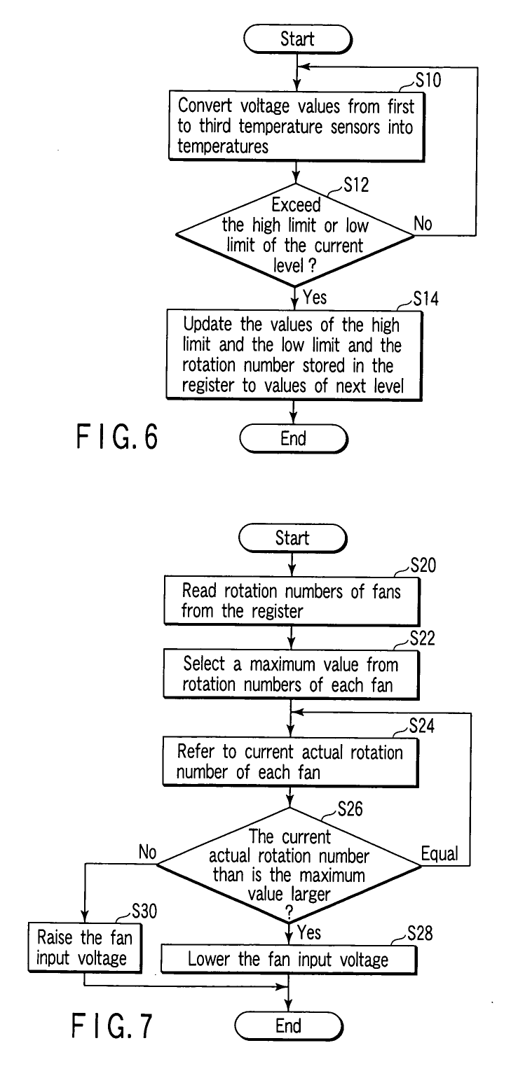

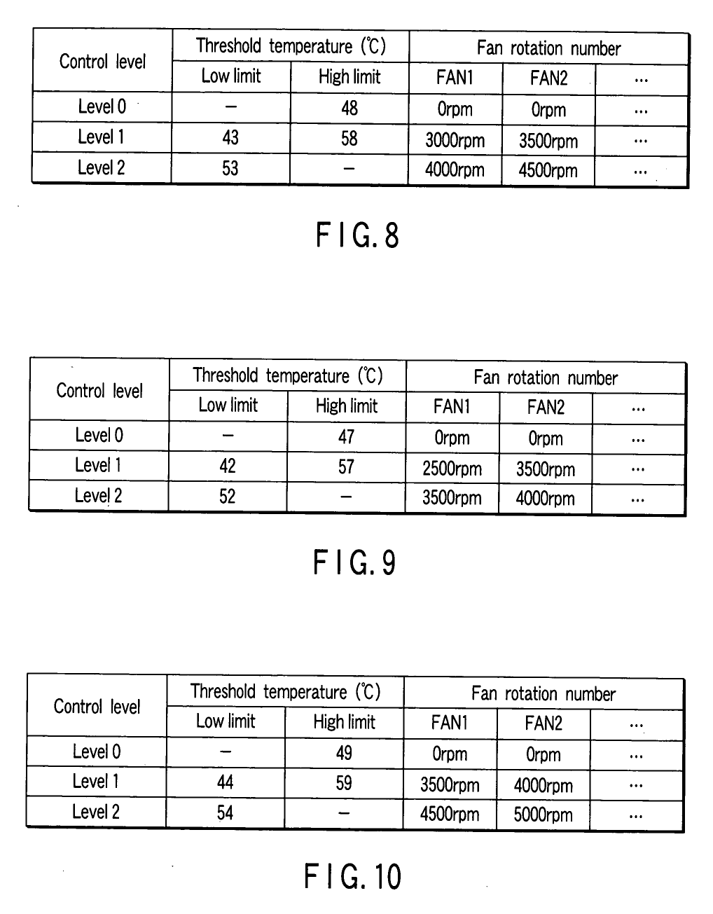

FIG. 5 is a block diagram illustrating a method of controlling the cooling fans, to which the information processing apparatus according to the embodiment of the present invention is applied. FIG. 6 is a flowchart illustrating changing a control level by the EC/KBC 211. FIG. 7 is a flowchart illustrating controlling the cooling fans by the EC/KBC 211. FIGS. 8 to 10 are schematic diagrams of respective control tables corresponding to the first to third temperature sensors 101a to 103a, stored in the table information storage area 211a of the EC/KBC 211.

As shown in FIG. 5, the control of the first fan 150 and the second fan 151 by the EC/KBC 211 is explained on the assumption that the EC/KBC 211 includes a controller intended for controlling the first fan 150 (first fan controller) and a controller intended for controlling the second fan 151 (second fan controller) (Actually, the EC/KBC 211 performs all the controls).

First, the register 211b of the EC/KBC 211 stores the current control values with which the first fan 150 and the second fan 151 are controlled.

FIGS. 12 and 13 are schematic diagrams of the register 211b storing the current control values.

As shown in FIG. 12, as the current control values, the low limit and the high limit of the first temperature sensor are set to 43° C. and 58° C. (Level 1), respectively. The low limit and the high limit of the second temperature sensor are set to 42° C. and 57° C. (Level 1), respectively. The low limit and the high limit of the third temperature sensor are set to 44° C. and 59° C. (Level 1), respectively. Further, as shown in FIG. 13, the rotation number of the first fan 150 is set to 3500, and the rotation number of the second fan 151 is set to 4000 (they are set to the maximum values described below).

In the above state, the present invention includes control table information of each of the temperature sensors. The control table information sets a plurality of predetermined temperature ranges as control levels, and designates the rotation numbers of each of the cooling fans corresponding to the respective control levels. The maximum value of each cooling fan is determined among the rotation numbers of the cooling fans corresponding to the control levels corresponding to the temperature information sent from the temperature sensors, and each cooling fan is controlled on the basis of the determined maximum value.

Specifically, each of the assumed first fan controller and the second fan controller in the EC/KBC 211 (refer to FIG. 5) converts voltage values, which have been received from the first temperature sensor 101a, the second temperature sensor 105a, and the third temperature sensor 103a in step S10, into temperatures, as shown in FIG. 6. One converted temperature value exists for each of the first to third temperature sensors. For example, suppose that the temperature of the first temperature sensor 101a is 40° C., the temperature of the second temperature sensor 105a is 55° C., and the temperature of the third temperature sensor 105a is 65° C.

Next, in step S12, the first fan controller and the second fan controller determine whether each converted temperature exceeds the range of the current threshold temperature for the corresponding temperature sensor stored in the register 211b, that is, the range from the low limit to the high limit of the corresponding temperature sensor.

For example, the temperature of the first temperature sensor 101a is 40° C., and exceeds the temperature range thereof, ranging from the low limit (43° C.) to high limit (58° C.), stored in the register 211b. Therefore, in step S14, threshold temperatures (low limit =−° C., high limit=48° C.) of next level, that is, level 0, are set in the register 211b to update the threshold temperatures for the first temperature sensor 101a in the register 211b (refer to FIG. 14).

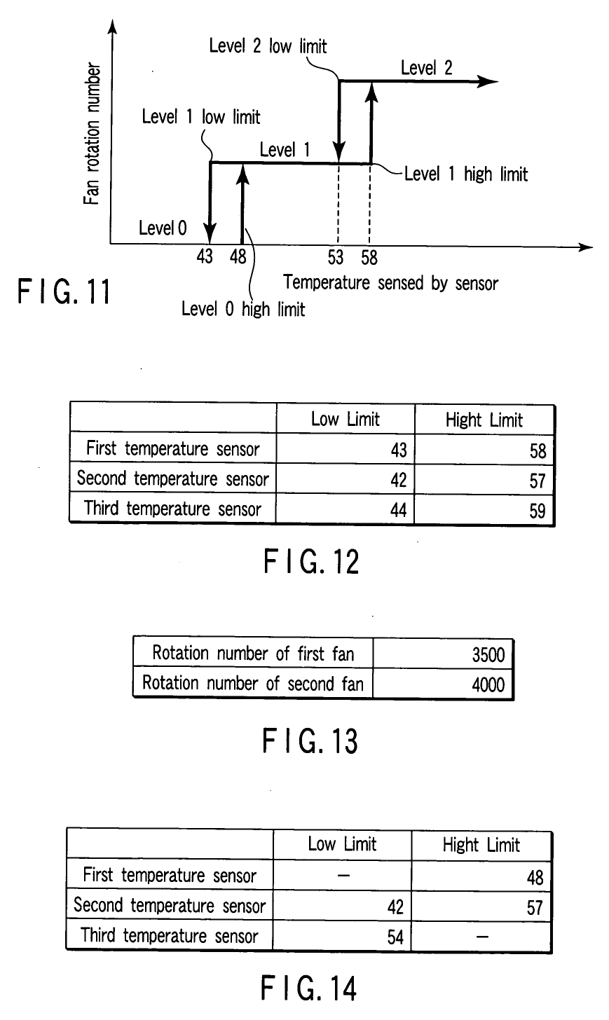

FIG. 11 is a schematic diagram illustrating transition of the control levels on the basis of the control table (FIG. 8) for the first temperature sensor 101a. For example, suppose that the current state of the first temperature sensor 101a is Level 1. If the temperature of the first temperature sensor 101a becomes lower than the low limit (43° C.) of the temperature range, the first temperature sensor 101a changes to Level 0 (if the current temperature thereof is 40° C.). If the temperature thereof becomes higher than the high limit (58° C.), the first temperature sensor 101a changes to Level 2. In the meantime, suppose that the current state of the first temperature sensor 101a is Level 0. If the temperature thereof becomes higher than the high limit (48° C.) of Level 0, the first temperature sensor 101a changes to Level 1. If the current state is Level 2 and the temperature thereof becomes lower than the low limit (53° C.) of Level 2, the first temperature sensor 101a changes to Level 1.

Further, as shown in FIG. 6, in step S12, for example, the temperature of the second temperature sensor 105a is 55° C. Since it falls within the temperature range (the same level) stored in the register 211b, that is, the range having the low limit of 42° C. and the high limit of 57° C. (Level 1) Therefore, the system goes to the step S10, and continues temperature monitoring. In this case, the values set in the register 211b are not updated, and the same values are maintained (refer to FIG. 14).

Further, for example, the temperature of the third temperature sensor 103a is 65° C., and exceeds the temperature range (Level 1) stored in the register 211b, that is, the temperature range having the low limit of 44° C. and the high limit of 59° C. Therefore, in step S14, the threshold temperatures (low limit=54° C., high limit=−° C.) of the next level, Level 2, are set in the register 211b to update the values for the third temperature sensor 103a (refer to FIG. 14).

In view of the above set levels of the temperature sensors, the first temperature sensor 101a is set to Level 0, the second temperature sensor 105a is maintained at Level 1, and the third temperature sensor 103a is set to Level 2.

FIG. 7 is a flowchart illustrating a processing of determining and controlling the rotation numbers of the cooling fans corresponding to the set levels, after setting levels by the processing of FIG. 6.

In step S20, the EC/KBC 211 reads the rotation numbers of the fans set in the register 211b, shown in FIG. 13. For example, the EC/KBC 211 reads a rotation number of 3500 of the first fan 150, and a rotation number of 4000 of the second fan 151.

Further, the EC/KBC 211 selects a control level corresponding to the threshold temperatures set in the register 211b, in each of the control tables (FIGS. 8 to 10) corresponding to the respective temperature sensors. For example, as described above, the first temperature sensor 101a is set to Level 0, the second temperature sensor 105a is maintained at Level 1, and the third temperature sensor 103a is set to Level 2. Then, the EC/KBC 211 reads the rotation numbers (A) of the fans corresponding to the selected control levels. For example, since the first temperature sensor 101a is set to Level 0, the rotation number of the first fan 150 is 0, and the rotation number of the second fan 151 is 0 (see FIG. 8). Since the second temperature sensor is set to Level 1, the rotation number of the first fan 150 is 2500, and the rotation number of the second fan 151 is 3500 (see FIG. 9). Since the third temperature sensor 105a is set to Level 2, the rotation number of the first fan 150 is 4500, and the rotation number of the second fan 151 is 5000 (see FIG. 10).

In step S22, the EC/KBC 211 compares the read values (A) of each fan, and selects the maximum value for each fan.

(Control of First Fan 150)

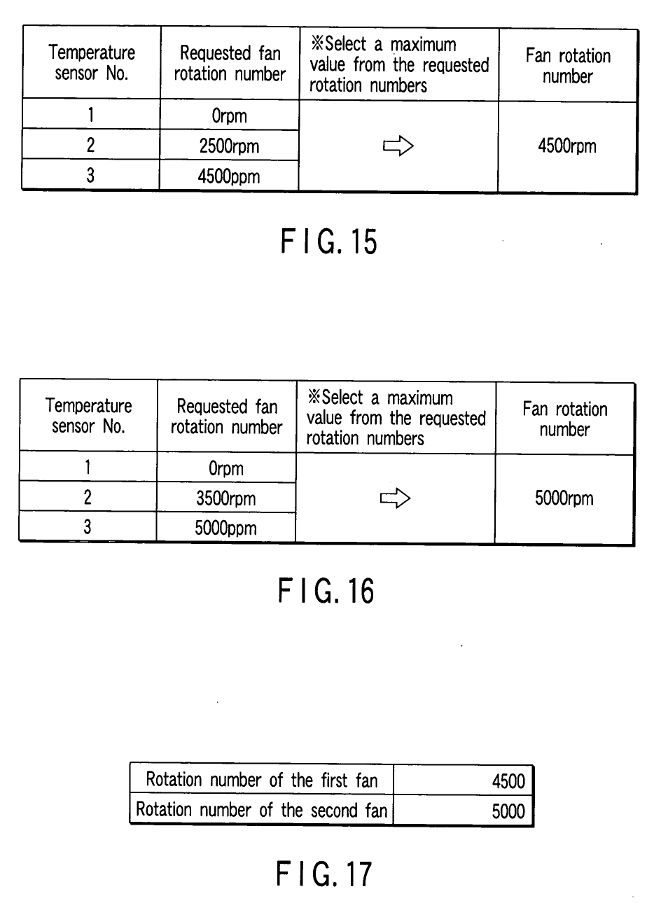

For example, as shown in FIG. 15, the first fan 150 has a rotation number 0 as the rotation number corresponding to the control table (FIG. 8) of the first temperature sensor 101a (rotation number requested by the first temperature sensor 101a), a rotation number 2500 as the rotation number corresponding to the control table (FIG. 9) of the second temperature sensor 105a (rotation number requested by the second temperature sensor 105a), and a rotation number 4500 as the rotation number corresponding to the control table (FIG. 10) of the third temperature sensor 103a (rotation number requested by the third temperature sensor 103a). Since the maximum value among these rotation numbers is 4500, the rotation number as a control target value of the first fan 150 is determined as 4500. Then, the rotation number of the first fan 150 stored in the register 211b is updated from the current set value 3500 (see FIG. 13) to 4500 (see FIG. 17).

Next, in step S24, the EC/KBC 211 refers to the current actual rotation number of each fan. For example, as shown in FIG. 5, the EC/KBC 211 obtains a rotation number signal α1 from the first fan 150.

In step S26, the EC/KBC 211 determines whether the above the current actual rotation number of the first fan 150 obtained is larger than maximum value. If the EC/KBC 211 determines that the current actual rotation number of the first fan 150 obtained is larger in step S26, the EC/KBC 211 performs control to lower the voltage of the first fan 150 (control to cause the current actual rotation number of the first fan 150 to approach the maximum value). The cooling fan is controlled by transmitting a control signal β1 from the virtual first fan controller in the EC/KBC 211 to the first fan 150, as shown in FIG. 5.

In the meantime, if the EC/KBC 211 determines that the maximum value is larger than the actual rotation value in step S26, the EC/KBC 211 performs control to raise the voltage of the first fan 150 (control to cause the current actual rotation number of the first fan 150 to approach the maximum value). The cooling fan is controlled by transmitting a control signal β1 in the same manner as the above. Further, if the EC/KBC 211 determines that the maximum value is equal to the current actual rotation number, the EC/KBC 211 does not perform control of the voltage of the first fan 150.

(Control of Second Fan 151)

For example, as shown in FIG. 16, the second fan 151 has a rotation number 0 as the rotation number corresponding to the control table (FIG. 8) of the first temperature sensor 101a (rotation number requested by the first temperature sensor 101a), a rotation number 3500 as the rotation number corresponding to the control table (FIG. 9) of the second temperature sensor 105a (rotation number requested by the second temperature sensor 105a), and a rotation number 5000 as the rotation number corresponding to the control table (FIG. 10) of the third temperature sensor 103a (rotation number requested by the third temperature sensor 103a). Since the maximum value among these rotation numbers is 5000, the rotation number as a control target value of the second fan 151 is determined as 5000. Then, the rotation number of the second fan 151 stored in the register 211b is updated from the current set value 4000 (see FIG. 13) to 5000 (see FIG. 17).

Next, in step S24, the EC/KBC 211 refers to the current actual rotation number of each fan. For example, as shown in FIG. 5, the EC/KBC 211 obtains a rotation number signal α2 from the second fan 151.

In step S26, the EC/KBC 211 determines whether the above maximum value is larger than the current actual rotation number of the second fan 151 obtained. If the EC/KBC 211 determines that the maximum value is larger in step S26, the EC/KBC 211 performs control to lower the voltage of the second fan 151 (control to cause the current actual rotation number of the second fan 151 to approach the maximum value). The cooling fan is controlled by transmitting a control signal β2 from the virtual second fan controller in the EC/KBC 211 to the second fan 151, as shown in FIG. 5.

In the meantime, if the EC/KBC 211 determines that the maximum value is smaller than the actual rotation value in step S26, the EC/KBC 211 performs control to raise the voltage of the second fan 151 (control to cause the current actual rotation number of the second fan 151 to approach the maximum value). The cooling fan is controlled by transmitting a control signal β2 in the same manner as the above. Further, if the EC/KBC 211 determines that the maximum value is equal to the current actual rotation number, the EC/KBC 211 does not perform control of the voltage of the second fan 151.

According to the above structure of the present invention, it is possible to appropriately control the cooling fans, even when the cooling fans are not provided in a one-to-one relationship with a plurality of objects to be cooled due to a restricted setting space of the cooling fans and the like. Further, the present invention comprises the control tables corresponding to information from the respective temperature sensors, and the cooling fans are controlled by using the respective maximum values selected from the rotation numbers of the cooling fans stored in the control tables. This provides a margin of the cooling performance, and increases the reliability.

Further, the present invention is not limited to the above embodiment, but can be realized when being carried out by modifying its constituent elements in a range not departing from the gist of the invention. Various inventions can be made by appropriately combining a plurality of constituent elements disclosed in the embodiment. For example, some of the constituent elements disclosed in the embodiment may be deleted. Further, constituent elements of different embodiments may be combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first heat-generating member;
a first temperature sensor which measures a temperature of the first heat-generating member;
a second heat-generating member;
a second temperature sensor which measures a temperature of the second heat-generating member;
a cooling fan;
a controller which selects a first rotation number based on the temperature measured by the first temperature sensor, selects a second rotation number based on the temperature measured by the second temperature sensor, selects one of the selected first rotation number and the selected second rotation number having a larger value, and controls the cooling fan with the selected rotation number having the larger value.

2. An information processing apparatus according to claim 1, further comprising:
a second cooling fan,
wherein the controller selects a third rotation number based on the temperature measured by the first temperature sensor, selects a fourth rotation number based on the temperature measured by the second temperature sensor, selects one of the selected third rotation number and the fourth rotation number having a larger value, and controls the second cooling fan with the selected rotation number having the larger value.

3. An information processing apparatus according to claim 1,
wherein the controller includes tables corresponding to the respective temperature sensors, and each table stores rotation numbers of the first cooling fan and rotation numbers of the second cooling fan corresponding to predetermined temperature ranges.

4. An information processing apparatus according to claim 1,
wherein a plurality of levels including a first level and a second level adjacent to the first level are assigned to the predetermined temperature ranges, and the predetermined temperature ranges are set such that a temperature range of the first level and a temperature level of the second level overlap in a range from a temperature, at which the cooling fan changes from the first level to the second level, to a temperature, at which the cooling fan changes from the second level to the first level.

5. An information processing apparatus comprising:
a first heat-generating member;
a first temperature sensor which measures a temperature of the first heat-generating member;
a second heat-generating member;
a second temperature sensor which measures a temperature of the second heat-generating member;
a first cooling fan and a second cooling fan;
a controller which includes control table information items corresponding to the respective temperature sensors, the control table information items setting a plurality of predetermined temperature ranges as control levels and each providing rotation numbers of the first cooling fan and rotation numbers of the second cooling fan corresponding to the predetermined temperature ranges, the controller determining a rotation number of the first cooling fan having a maximum value in the rotation numbers of the first cooling fan corresponding to the control levels corresponding to the temperatures measured by the first and the second temperature sensors, and a rotation number of the second cooling fan having a maximum value in the rotation numbers of the second cooling fan corresponding to the control levels corresponding to the temperatures measured by the first and the second temperature sensors, controlling the first cooling fan based on the determined rotation number of the first cooling fan, and controlling the second cooling fan based on the determined rotation number of the second cooling fan.

6. A method of controlling an information processing apparatus including a first heat-generating member, a first temperature sensor which measures a temperature of the first heat-generating member, a second heat-generating member, a second temperature sensor which measures a temperature of the second heat-generating member, a cooling fan, and a controller which controls the cooling fan, the method comprising:
a first selecting step of selecting a first rotation number based on the temperature measured by the first temperature sensor;
a second selecting step of selecting a second rotation number based on the temperature measured by the second temperature sensor;
a third selecting step of selecting one of the selected first rotation number and the selected second rotation number having a larger value; and
and a controlling step of controlling the cooling fan by the controller with the selected rotation number having the larger value selected by the third selecting step.

7. A method according to claim 6,
wherein the information processing apparatus further comprises a second cooling fan, and
the controller selects a third rotation number based on the temperature measured by the first temperature sensor, selects a fourth rotation number based on the temperature measured by the second temperature sensor, selects one of the selected third rotation number and the fourth rotation number having a larger value, and controls the second cooling fan with the selected rotation number having the larger value.

8. A method according to claim 6,
wherein the controller includes tables corresponding to the respective temperature sensors, and each table stores rotation numbers of the first cooling fan and rotation numbers of the second cooling fan corresponding to predetermined temperature ranges.

9. A method according to claim 6,
wherein a plurality of levels including a first level and a second level adjacent to the first level are assigned to the predetermined temperature ranges, and the predetermined temperature ranges are set such that a temperature range of the first level and a temperature level of the second level overlap in a range from a temperature, at which the cooling fan changes from the first level to the second level, to a temperature, at which the cooling fan changes from the second level to the first level.
